(19) United States
(12) Patent Application Publication
(10) Pub. No.: US 2026/0143377 A1
(43) Pub. Date: May 21, 2026

(54) INTELLIGENT UE AND NETWORK SELECTION ON NETWORK TYPE

(71) Applicant: AT&T Intellectual Property I, L.P., Atlanta, GA (US)

(72) Inventors: Zhi Cui, Sugar Hill, GA (US); Hongyan Lei, Plano, TX (US); Ye Chen, Marietta, GA (US)

(73) Assignee: AT&T Intellectual Property I, L.P., Atlanta, GA (US)

(21) Appl. No.: 18/953,212

(22) Filed: Nov. 20, 2024

(51) Int. Cl. H04W 28/02

(52) U.S. Cl. CPC H04W 28/0247; H04W 28/0215

(57) ABSTRACT

A system selects a network type for a UE to communicate with a network. The network type may be a classical radio access network (RAN) or a virtual RAN. The selection process may be device-driven, network-driven, or a combination. A network device may collect and analyze network performance data and UE processing capabilities to determine and reconfigure the optimal network type. The UE may gather data, receive network recommendations, and communicates its preference. Other embodiments are disclosed.

### FIELD OF THE DISCLOSURE

The subject disclosure relates to a selection of a network type for user equipment (UE) communications.

### BACKGROUND

The advancement of next-generation networks has made virtualization an aspect for improved programmability and flexibility. Virtualization is extending to various network components. Future networks will have more advanced features such as adaptive protocols, requiring network components to be more adaptive. Virtualized components, also referred to as cloud-based components, are more agile due to their programmability and cloud-native nature by design, making them useful for certain applications.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in which network selection is UE driven in accordance with various aspects described herein.

FIG. 2C is a block diagram illustrating an example, non-limiting embodiment of a system functioning within the communication network of FIG. 1 in which network selection is network driven in accordance with various aspects described herein.

FIGS. 2D and 2E depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for intelligent network type selection. Other embodiments are described in the subject disclosure.

Various embodiments described herein provide for various apparatus and methods to select an optimal network type. For example, in some embodiments, a user equipment (UE) and a network continuously collect real-time data. The UE may gather information about its current processing capabilities, battery status, and the requirements of the running applications (e.g., extended reality “XR” applications, metaverse applications, and the like). The network may collect data on current load conditions, available bandwidth, latency, and the performance of different network types (e.g., classical RAN and vRAN).

In some embodiments, both the UE and the network utilize artificial intelligence/machine learning (AI/ML) algorithms to analyze the collected data. For example, an AI/ML engine on the network side may process the network performance data and application requirements to determine the most suitable network type. Also for example, an AI/ML client on the UE side may evaluate its own capabilities and the recommendations received from the network.

Based on the analysis, the AI/ML engine on the network side may make a recommendation for the optimal network type. For example, if the application running on the UE requires high processing power and low latency, and the vRAN is currently underutilized, the network may recommend connecting to, or switching to, the vRAN. In some embodiments, the UE's AI/ML client can either accept this recommendation or make its own decision based on its internal analysis.

In some embodiments, the UE and the network communicate to finalize the network type selection. For example, the UE may send a request to the network to switch to the recommended network type if it agrees with the recommendation. The network may then process this request and initiate the switch, ensuring minimal disruption to the ongoing services.

In some embodiments, the network reconfigures the connection to route the UE's traffic through the selected network type. If the vRAN is chosen, the network allocates the necessary resources to support the UE's application requirements. The UE adjusts its settings to optimize performance based on the new network type.

In some embodiments, the process is dynamic and continuous. Both the UE and the network may keep monitoring the performance and conditions. If there are significant changes, such as increased network load or changes in the UE's application requirements, the process repeats to ensure the optimal network type is always selected. This process ensures that the UE is always connected to the most suitable network type, increasing resource utilization and enhancing the overall user experience.

As used herein, the term “optimal network type” refers to a selected network configuration that can best meet the specific requirements of a given application or user equipment (UE) at any given time. This involves selecting between different types of Radio Access Networks (RANs), such as classical RAN and virtualized RAN (vRAN), based on various factors including network load conditions, device capabilities, application processing power needs, and Quality of Experience (QoE) requirements. In some embodiments, the optimal network type may be determined by leveraging AI/ML algorithms that analyze real-time data from both the network and the UE to make informed decisions. By selecting the optimal network type, the system aims to enhance overall performance, ensure efficient resource utilization, and provide a seamless and high-quality user experience, particularly for processing-intensive applications like XR and metaverse services.

One or more aspects of the subject disclosure include a network device that includes a processing system having a processor and a memory that stores executable instructions. When executed by the processing system, these instructions facilitate the performance of operations. The operations may include collecting network performance data describing current network load conditions, receiving data from a user equipment (UE) about the current processing capabilities of the UE, analyzing the network performance data and the data from the UE to determine a suitable network type, and reconfiguring a network connection to route the traffic of the UE through the suitable network type.

One or more aspects of the subject disclosure include a non-transitory machine-readable medium that contains executable instructions that, when executed by a processing system including a processor, perform operations. The UE collects data about its current processing capabilities and application requirements. The UE provides this data to a network device. The UE receives a recommendation from the network device regarding a suitable network type, which could be either a classical RAN or a vRAN. The UE analyzes the recommendation to make a decision on a preferred network type between the classical RAN and the vRAN. The UE communicates its preferred network type to the network device.

One or more aspects of the subject disclosure include a method for intelligent network selection by a user equipment (UE). The method may include many actions. The UE collects real-time data about its current processing capabilities, battery status, and application requirements. The UE receives a recommendation from an AI/ML engine on the network side regarding a suitable network type, which could be either a classical Radio Access Network (RAN) or a virtualized Radio Access Network (vRAN), based on network performance data and application requirements. The UE analyzes the received recommendation and its own internal data to make a decision on the optimal network type between the classical RAN and the vRAN. The UE communicates its network type preference to the network and requests additional processing power if needed. The UE adjusts its settings to optimize performance based on the selected network type. The UE continuously monitors its performance and conditions to ensure the optimal network type is maintained. The UE dynamically re-evaluates the network type selection in response to significant changes in network load or application requirements, and repeats the process to ensure optimal connectivity and resource utilization.

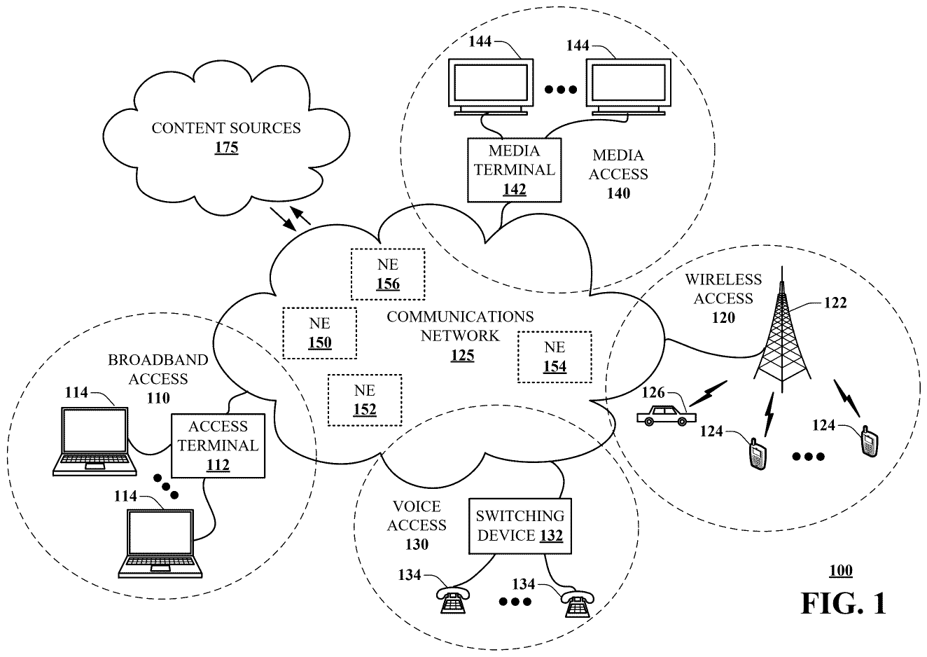

Referring now to FIG. 1, a block diagram is shown illustrating an example, non-limiting embodiment of a system 100 in accordance with various aspects described herein. For example, system 100 can facilitate in whole or in part intelligent network type selection. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

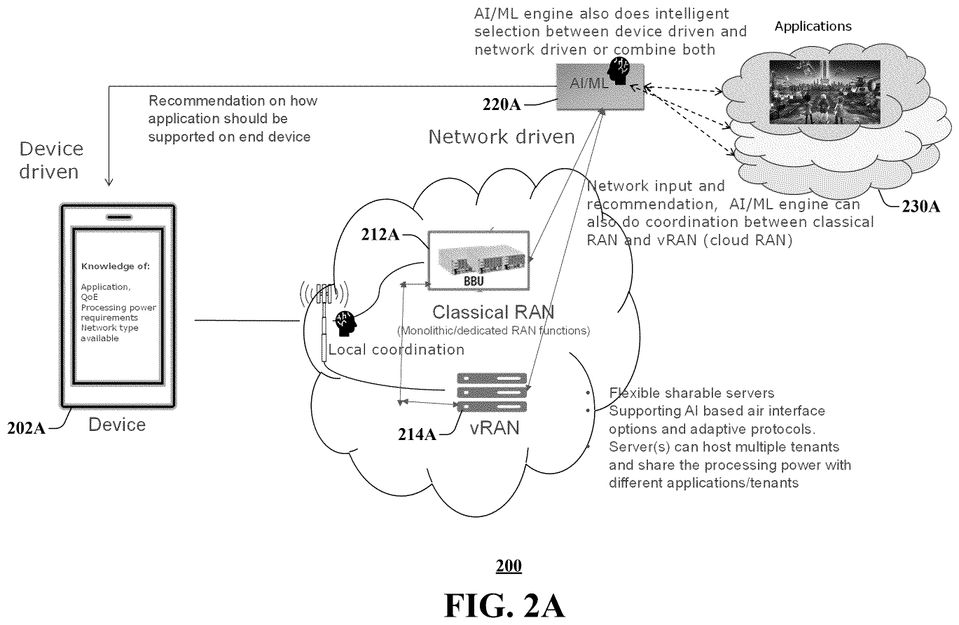

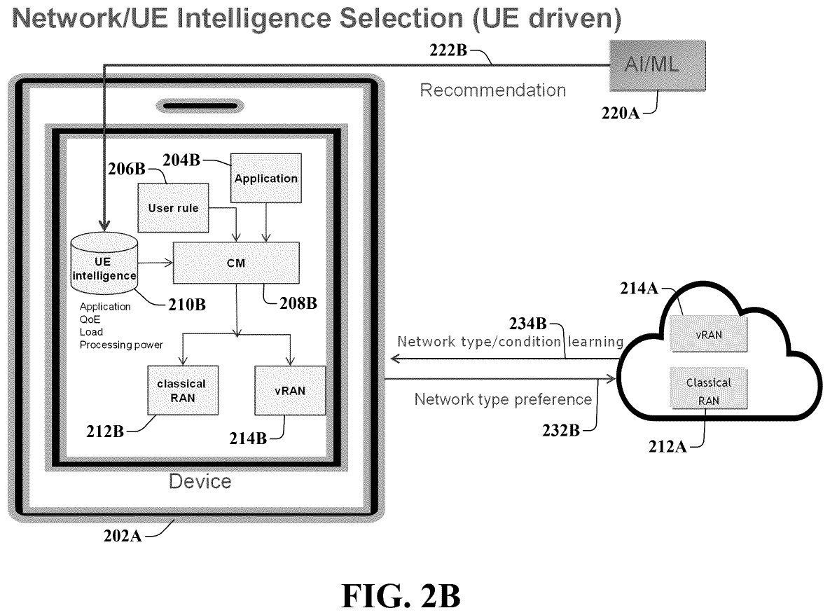

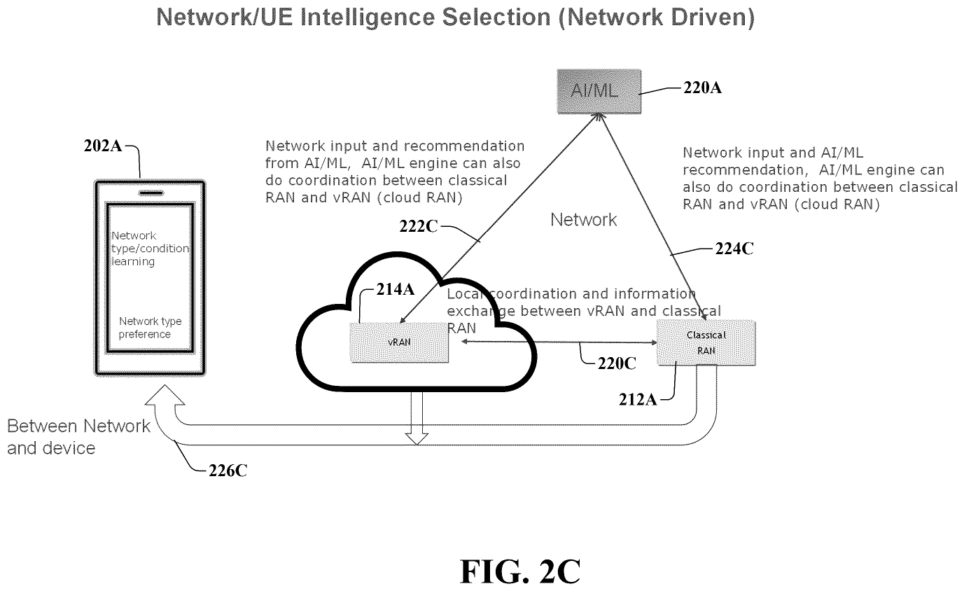

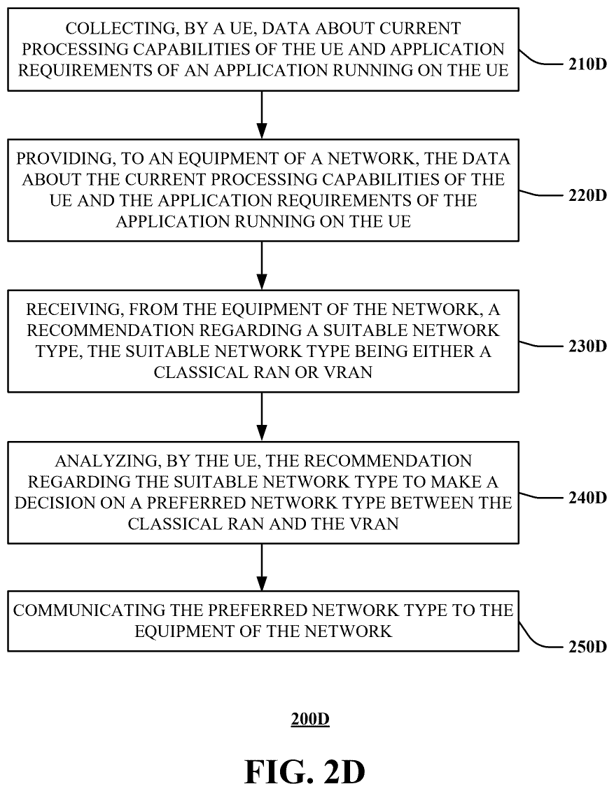

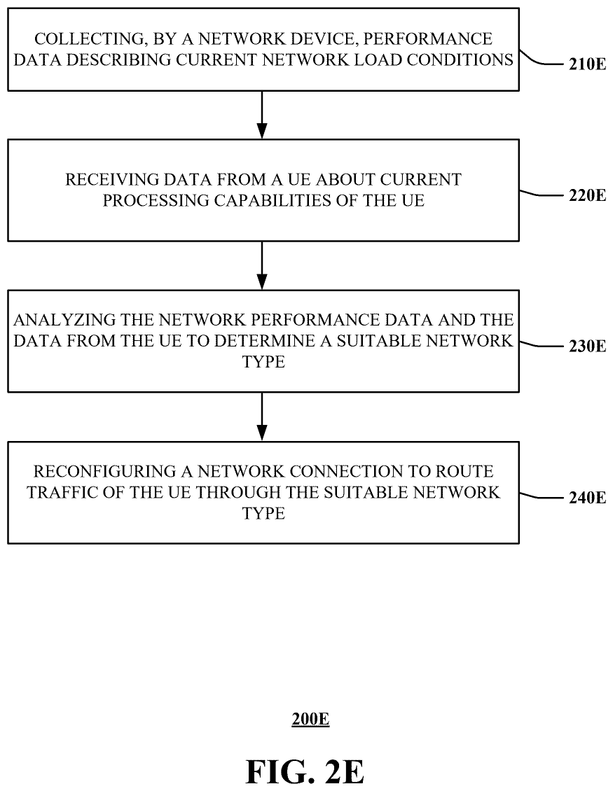

FIG. 2A is a block diagram illustrating an example, non-limiting embodiment of a system functioning within the communication network of FIG. 1 in accordance with various aspects described herein. System 200 illustrates interactions between a user equipment (UE) 202A, an AI/ML engine 220A, applications 230A, a classical Radio Access Network (RAN) 210A, and a virtualized Radio Access Network (vRAN) 214A.

UE 202A represents a user equipment device that collects data about its current processing capabilities, battery status, and the requirements of the running applications. In some embodiments, UE 202A may be implemented by various mobile devices such as smartphones, tablets, or other computing devices. For example, UE 202A may be a user device that gathers information about its battery status, CPU usage, and the specific needs of running applications such as XR or metaverse services.

AI/ML engine 220A represents an artificial intelligence/machine learning engine that processes data from the network and the UE to make intelligent decisions on the preferred network type. In some embodiments, AI/ML engine 220A may be implemented by cloud-based AI/ML systems or on-premises AI/ML servers. For example, AI/ML 220A may be implemented by a cloud-based system and may analyze network performance data and application requirements to determine the most suitable network type.

Applications 230A represent the various services and applications that the UE 202A may run, which require different levels of processing power and network performance. In some embodiments, applications 230A may include XR, metaverse, and other immersive services. For example, applications 230A may include an XR application that requires a high level of processing power.

Classical RAN 212A represents monolithic or dedicated RAN functions that are typically implemented on specialized hardware. In some embodiments, classical RAN 212A may be implemented by traditional RAN infrastructure. For example, classical RAN 212A may perform baseband processing, radio resource management, and signal processing using dedicated hardware units. vRAN 214A represents a virtualized Radio Access Network that leverages cloud-native technologies to enhance the flexibility and programmability of network infrastructure. In some embodiments, vRAN 214A may be implemented by cloud-based RAN systems. For example, vRAN 214A may virtual network functions such as baseband processing and deploy them on cloud infrastructure, facilitating multi-tenancy and dynamic resource allocation.

As shown in FIG. 2A, a selection of network type (e.g., classical RAN or vRAN) may be made by a UE 202A, a network, or both. In some embodiments, (e.g., UE driven embodiments), UE 202A provides the network an indication of a preferred network type, and in other embodiments, (e.g., network driven embodiments), the network may determine a suitable network type and communicate the suitable network type to the UE. In all cases, the end decision of network type may be made by the UE, the network, or both.

The vRAN 214A, or virtualized Radio Access Network, leverages cloud-native technologies to enhance the flexibility and programmability of network infrastructure. The vRAN architecture decouples hardware and software components, allowing network functions to run on general-purpose hardware. This separation enables dynamic resource allocation and scalability, which support the diverse and evolving requirements of modern wireless networks, including 5G and 6G.

In vRAN 214A, network functions such as baseband processing are virtualized and can be deployed on cloud infrastructure. This approach facilitates multi-tenancy, where multiple network operators or services can share the same physical infrastructure while maintaining isolation and security. The cloud-native nature of vRAN allows for rapid deployment and updates of network functions, improving the agility and responsiveness of the network to changing demands and conditions.

The vRAN architecture supports advanced features such as AI-based air interface options and adaptive protocols, which are provide for the efficient operation of 5G and 6G networks. By utilizing AI and machine learning algorithms, the vRAN can optimize network performance, manage resources more effectively, and provide tailored services to different applications and user equipment (UE). These capabilities may be beneficial for processing-intensive applications like XR and metaverse services, where the network can offload some of the processing tasks from the UE, enhancing the overall user experience.

Furthermore, the vRAN's ability to host multiple tenants and share processing power among different applications and services makes the vRAN a preferred choice for network type selection in various scenarios. The vRAN can dynamically allocate resources based on real-time network conditions and application requirements, ensuring optimal performance and efficient utilization of network resources.

The classical Radio Access Network (RAN) 212A, as depicted in FIG. 2A, comprises monolithic or dedicated RAN functions that are typically implemented on specialized hardware. Unlike the virtualized RAN (vRAN) 214A, which leverages cloud-native technologies for enhanced flexibility and programmability, the classical RAN 212A operates with a more traditional architecture where hardware and software components are tightly integrated. This integration often results in a fixed allocation of resources, which can limit the adaptability and scalability of the network infrastructure.

In the classical RAN 212A, network functions such as baseband processing, radio resource management, and signal processing are performed by dedicated hardware units. These units are designed to handle specific tasks and are optimized for performance, but they lack the dynamic resource allocation capabilities of a virtualized environment. As a result, the classical RAN 212A may face challenges in efficiently managing varying network loads and adapting to the diverse requirements of modern wireless applications.

Despite these limitations, the classical RAN 212A remains a component of many existing wireless networks due to proven reliability and performance. The dedicated nature of the hardware allows for predictable and consistent operation, which is necessary for maintaining high-quality service levels. As the demand for more flexible and scalable network solutions grows, the classical RAN 212A may be complemented or gradually replaced by more adaptive architectures like the vRAN 214A to meet the evolving needs of next-generation networks.

In operation, the UE 202A collects data about its current processing capabilities, battery status, and the requirements of the running applications. This data may then be communicated to the AI/ML engine 220A, which resides within the network. The AI/ML engine 220A processes this data along with network performance data to make an intelligent decision on the preferred network type.

In some embodiments, the AI/ML engine 220A may decide whether the RAN selection is network-driven or device-driven (e.g., UE driven). In a network-driven scenario, the AI/ML engine 220A analyzes the network input and provides recommendations to the UE 202A on the suitable network type. The network input may include data on current load conditions, available bandwidth, latency, and the performance of different network types. The AI/ML engine 220A may also coordinate between the classical RAN 210A and the vRAN 214A to optimize resource utilization and enhance service delivery.

In a device-driven scenario, the UE 202A, equipped with an AI/ML client, receives recommendations from the AI/ML engine 220A on how the application should be supported on the end device. The UE 202A can then use this recommendation along with its own internal analysis to identify a preferred network type. The UE 202A communicates its network type preference to the network and requests additional processing power if needed. The AI/ML engine 220A facilitates local coordination between the classical RAN 210A and the vRAN 214A to ensure seamless service delivery.

Additionally, the UE 202A can first provide a preferred network type to the network based on its internal analysis. The network, using the AI/ML engine 220A, may then make the final decision on the network type based on the UE's preference and further analysis performed by the network. This ensures that the network type selection is optimized for both the UE's capabilities and the network's performance conditions.

The applications 230A represent the various services and applications that the UE 202A may run, which require different levels of processing power and network performance. The AI/ML engine 220A continuously learns from the network input and application requirements to make optimal network selection decisions, ensuring that the UE 202A is connected to the most suitable network type.

FIG. 2B is a block diagram illustrating an example, non-limiting embodiment of a system functioning within the communication network of FIG. 1 in which network selection is UE driven in accordance with various aspects described herein. The user equipment (UE) 202A interacts with various components to facilitate intelligent network type selection. In some embodiments, the UE 202A collects data about the current processing capabilities, battery status, and the requirements of the running applications. This data may be used for making informed decisions regarding the optimal network type for the UE 202A. In some embodiments, the UE 202A processes this information internally, and in other embodiments, the UE 202A may communicate the information to the network for further analysis.

In some embodiments, the AI/ML engine 220A plays a role in analyzing the data collected by the UE 202A. For example, the AI/ML engine 220A may process the network performance data and application requirements to determine the most suitable network type. The AI/ML engine 220A may also provide recommendations to the UE 202A on how the application can be supported on the end device. In some embodiments, the AI/ML engine 220A continuously learns from the network input and application requirements to make optimal network selection decisions, ensuring that the UE 202A is connected to the most suitable network type.

In some embodiments, a network type recommendation 222B is generated by the AI/ML engine 220A based on the analysis of the network performance data and the data from the UE 202A. The network type recommendation 222B provides guidance to the UE 202A on the suitable network type, which could be either a classical Radio Access Network (RAN) or a virtualized Radio Access Network (vRAN). The UE 202A can analyze the network type recommendation 222B to make a decision on a preferred network type between the classical RAN and the vRAN.

The network type/condition learning 234B component is responsible for continuously monitoring the current network load conditions and updating the suitable network type based on real-time data. This component ensures that the network type selection is optimized for the current network conditions and the requirements of the running applications on the UE 202A.

In some embodiments, the network type preference 232B is determined by the UE 202A based on the analysis of the network type recommendation 222B and the internal data of the UE 202A. The UE 202A communicates the network type preference 232B to the network, which may then reconfigure the network connection to route the traffic of the UE 202A through a network connection having the type of the network type preference 232B.

The CM 208B, or Configuration Manager, is responsible for managing the configuration settings of the UE 202A and the network. The CM 210B ensures that the network type selection process is aligned with the configuration settings and policies of the network and the UE 202A. The CM 210B facilitates the communication between the UE 202A and the network, ensuring that the network type selection process is seamless and efficient. As a result of the network type selection process, CM 210B configures the UE 202A for either a classical RAN network connection 212B or vRAN network connection 214B.

In some embodiments, a decision to use the vRAN network connection 214B is made by the AI/ML engine 220A or the UE 202A based on the analysis of the network performance data and the application requirements. If the vRAN 214A is determined to be the most suitable network type, the network connection is reconfigured to route the traffic of the UE 202A through the vRAN 214A. The vRAN network connection 214B ensures that the UE 202A is connected to the most suitable network type, optimizing resource utilization and enhancing the overall user experience.

In some embodiments, a decision to use the classical RAN network connection 212B is made by the AI/ML engine 220A or the UE 202A based on the analysis of the network performance data and the application requirements. If the classical RAN 212A is determined to be the most suitable network type, the network connection is reconfigured to route the traffic of the UE 202A through the classical RAN 212A. The classical RAN network connection 212B ensures that the UE 202A is connected to the most suitable network type, optimizing resource utilization and enhancing the overall user experience.

The application 204B represents the various services and applications that the UE 202A may run, which require different levels of processing power and network performance. The application 204B provides data on the application requirements, which is used by the AI/ML engine 220A and the UE 202A to make informed decisions on the optimal network type. The application 204B ensures that the network type selection process is aligned with the requirements of the running applications, optimizing performance and enhancing the overall user experience.

The user rules 206B are predefined rules set by the user or the network operator that guide the network type selection process. The user rules 206B may include preferences for certain network types, thresholds for network performance metrics, and other criteria that influence the network type selection process. The user rules 206B ensure that the network type selection process is aligned with the preferences and requirements of the user, optimizing performance and enhancing the overall user experience.

The UE intelligence 210B represents the internal intelligence of the UE 202A, which includes the AI/ML client and other processing capabilities. The UE intelligence 210B analyzes the data collected by the UE 202A and the recommendations received from the network to make informed decisions on the optimal network type. The UE intelligence 210B ensures that the network type selection process is aligned with the capabilities and requirements of the UE 202A, optimizing performance and enhancing the overall user experience.

FIG. 2C is a block diagram illustrating an example, non-limiting embodiment of a system functioning within the communication network of FIG. 1 in which network selection is network driven in accordance with various aspects described herein. The system includes a user equipment (UE) 202A, an AI/ML engine 220A, a classical Radio Access Network (RAN) 212A, and a virtualized Radio Access Network (vRAN) 214A. The AI/ML engine 220A processes network input and provides recommendations for network type selection. The AI/ML engine 220A can also coordinate between the classical RAN 212A and the vRAN 214A to optimize resource utilization and enhance service delivery.

The UE 202A collects data about the current processing capabilities and application requirements. This data is communicated to the AI/ML engine 220A, which analyzes the network performance data and the data from the UE 202A to determine a suitable network type. The AI/ML engine 220A provides recommendations to the UE 202A on the suitable network type, which could be either the classical RAN 212A or the vRAN 214A. The UE 202A can then communicate the network type preference to the network.

The AI/ML engine 220A facilitates local coordination and information exchange between the classical RAN 212A and the vRAN 214A. This coordination ensures that the network type selection is optimized for both the UE's capabilities and the network's performance conditions. The communication between the network and the UE 202A is depicted by the communication link 226C, which allows the UE 202A to send the network type preference to the network and receive recommendations from the AI/ML engine 220A.

The network input and AI/ML recommendation 224C component is responsible for continuously monitoring the current network load conditions and updating the suitable network type based on real-time data. This component ensures that the network type selection is optimized for the current network conditions and the requirements of the running applications on the UE 202A.

The local coordination between the classical RAN and vRAN 220C component ensures seamless service delivery by dynamically allocating resources based on real-time network conditions and application requirements. This coordination allows the network to offload some of the processing tasks from the UE 202A to the vRAN 214A, enhancing the overall user experience.

AI/ML 220A is an example of a network device that includes a processing system with a processor and a memory that stores executable instructions. These instructions facilitate operations such as collecting network performance data describing current network load conditions and receiving data from the UE about its current processing capabilities. The AI/ML engine 220A analyzes this data to determine a suitable network type and reconfigures the network connection to route the UE's traffic through the selected network type. The network device continuously monitors the current network load conditions and updates the suitable network type accordingly.

In some embodiments, the AI/ML engine 220A provides recommendations to the UE on the suitable network type and receives the UE's network type preference. The reconfiguration of the network connection involves routing the UE's traffic through a network connection that matches the UE's preference. The network performance data includes available bandwidth, latency, and the performance of different network types. The data from the UE includes battery status and application requirements, which are essential for making informed decisions about the optimal network type.

FIG. 2D illustrates a method 200D for intelligent network selection by a user equipment (UE) in accordance with various aspects herein. In some embodiments, the actions of method 200D may be performed by a UE, a processing system, or the like.

At 210D, data about current processing capabilities and application requirements may be collected by a UE. In some embodiments, the actions of block 210D may be performed by the UE such as UE 202A as it collects data about its current processing capabilities and application requirements. For example, the UE may gather information about its battery status, CPU usage, and the specific needs of running applications such as XR or metaverse services. This data collection is useful for making informed decisions about the optimal network type. The data collected by the UE may also include battery status and Quality of Experience (QoE) requirements for the running applications.

At 220D, the data about the current processing capabilities of the UE and the application requirements of the application running on the UE may be provided to an equipment of the network. In some embodiments, the actions of block 220D may be performed by the UE providing the collected data to an equipment of the network. For example, the UE may transmit information about its current processing capabilities and application requirements to a network server or AI/ML engine for further analysis. This step ensures that the network has accurate and up-to-date information to make a suitable network type recommendation.

At 230D, a recommendation regarding a suitable network type is received from the network. In some embodiments, the actions of block 230D may be performed by the UE receiving a recommendation from the network regarding a suitable network type. For example, the network may analyze the data provided by the UE and recommend either a classical Radio Access Network (RAN) or a virtualized Radio Access Network (vRAN) based on current network load conditions and available resources. The recommendation may include an analysis of current network load conditions, available bandwidth, and other performance metrics.

At 240D, the recommendation regarding the suitable network type is analyzed to make a decision on a preferred network type. In some embodiments, the actions of block 240D may be performed by the UE analyzing the received recommendation to make a decision on a preferred network type. For example, the UE may compare the network's recommendation with its own internal data, such as battery status and application requirements, to determine whether to connect to the classical RAN or the vRAN. The decision on the preferred network type may be based on a comparison of processing power requirements of the application and the current processing capabilities of the UE.

At 250D, the preferred network type is communicated to the equipment of the network. In some embodiments, the actions of block 250D may be performed by the UE communicating its preferred network type to the network. For example, the UE may send a message to the network indicating its decision to connect to either the classical RAN or the vRAN, based on the analysis performed in the previous block. This communication ensures that the network is aware of the UE's preference and can reconfigure the network connection accordingly.

In some embodiments, method 200D includes actions performed by the UE adjusting its settings to optimize performance based on the preferred network type. For example, the UE may modify its network configuration to enhance connectivity and resource utilization. This adjustment ensures that the UE operates efficiently and maintains a high-quality user experience.

In some embodiments, method 200D includes actions performed by the UE continuously monitoring its performance and conditions to ensure the optimal network type is maintained. For example, the UE may periodically check network conditions and adjust its network type selection to maintain optimal connectivity and resource utilization. This continuous monitoring allows the UE to dynamically re-evaluate the network type preference in response to changes in network load or application requirements.

In some embodiments, method 200D includes actions performed by the UE storing historical data on network performance and application requirements to improve future network type selection decisions. For example, the UE may maintain a log of past network conditions and application performance to make more informed decisions in the future. This historical data helps the UE to learn from previous experiences and optimize its network type selection process over time.

In some embodiments, method 200D includes actions performed by the UE dynamically re-evaluating the network type preference in response to significant changes in network load or application requirements. For example, if the network load increases or the application requirements change, the UE may re-assess the network type selection to ensure optimal connectivity and resource utilization. This dynamic re-evaluation ensures that the UE is always connected to the most suitable network type, optimizing resource utilization and enhancing the overall user experience.

FIG. 2E illustrates a method 200E for intelligent network selection by a network device. In some embodiments, the actions of method 200D may be performed by a network device, a processing system, or the like.

At 210E, performance data describing current network load conditions are collected. In some embodiments, the actions of block 210E may be performed by the network device collecting performance data describing current network load conditions. For example, the network device may gather information about available bandwidth, latency, and the performance of different network types (e.g., classical RAN and vRAN). This data collection is useful for making informed decisions about the optimal network type.

At 220E, data about current processing capabilities of the UE are received. In some embodiments, the actions of block 220E may be performed by the network device receiving data from a UE about its current processing capabilities. For example, the UE may transmit information about its battery status, CPU usage, and the specific needs of running applications such as XR or metaverse services to the network device. This step ensures that the network device has accurate and up-to-date information to make a suitable network type recommendation.

At 230E, the network performance data and the data from the UE are analyzed to determine a suitable network type. In some embodiments, the actions of block 230E may be performed by the network device analyzing the network performance data and the data from the UE to determine a suitable network type. For example, the network device may evaluate current network load conditions, available bandwidth, latency, and the performance of different network types to make an informed decision. The analysis may also consider the UE's battery status and application requirements to ensure optimal network type selection. In some embodiments, the network type selection selects between a classical RAN and a vRAN.

At 240E, a network connection is reconfigured to route traffic of the UE through the suitable network type. In some embodiments, the actions of block 240E may be performed by the network device reconfiguring a network connection to route traffic of the UE through the suitable network type. For example, if the network device determines that the vRAN is the most suitable network type, it may reconfigure the network connection to route the UE's traffic through the vRAN. Also for example, if the network device determines that the classical RAN is the most suitable network type, it may reconfigure the network connection to route the UE's traffic through the classical RAN. This reconfiguration ensures that the UE is connected to the most suitable network type, optimizing resource utilization and enhancing the overall user experience.

In some embodiments, method 200E includes actions performed by the network device continuously monitoring the current network load conditions and updating the suitable network type. For example, the network device may track real-time data on network traffic, congestion levels, and resource availability to ensure optimal network type selection. This continuous monitoring allows the network device to dynamically re-evaluate the network type preference in response to changes in network load or application requirements.

In some embodiments, method 200E includes actions performed by the network device providing a recommendation to the UE on the suitable network type and receiving the UE's network type preference. For example, the AI/ML engine may suggest switching to the vRAN if it is underutilized and can better support the UE's application requirements. The UE may then communicate its preference back to the network. The reconfiguration of the network connection involves routing the UE's traffic through a network connection that matches the UE's preference.

In some embodiments, method 200E includes actions performed by the network device reconfiguring the network connection to route the traffic of the UE through a network connection having the type of the network type preference. For example, if the UE prefers the vRAN, the network device may reconfigure the network connection to route the UE's traffic through the vRAN, ensuring optimal connectivity and resource utilization.

In some embodiments, method 200E includes actions performed by the network device continuously monitoring the current network load conditions and updating the suitable network type. For example, the network device may track real-time data on network traffic, congestion levels, and resource availability to ensure optimal network type selection. This continuous monitoring allows the network device to dynamically re-evaluate the network type preference in response to changes in network load or application requirements.

While for purposes of simplicity of explanation, the respective processes are shown and described as a series of blocks in FIGS. 2D and 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

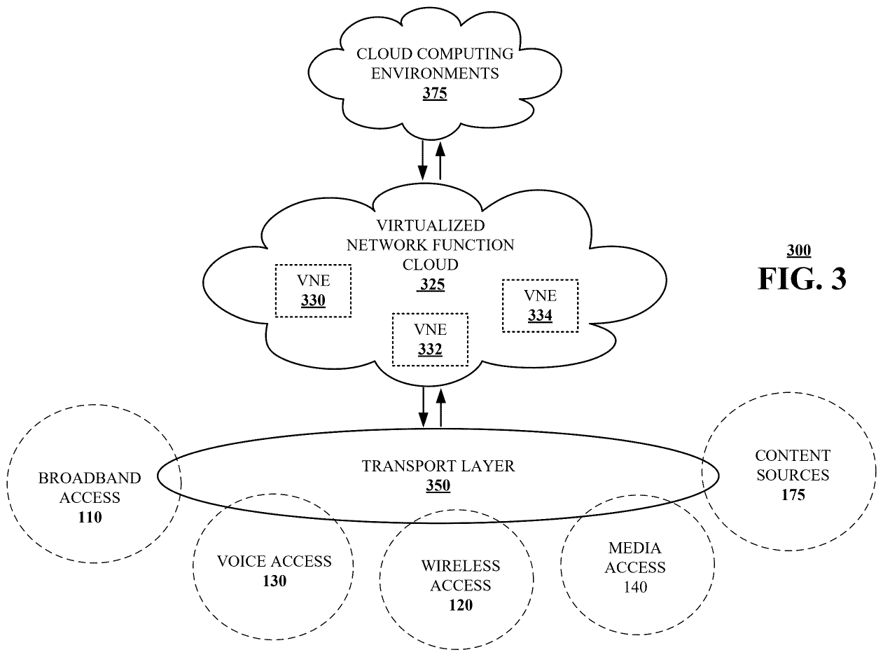

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part intelligent network type selection.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

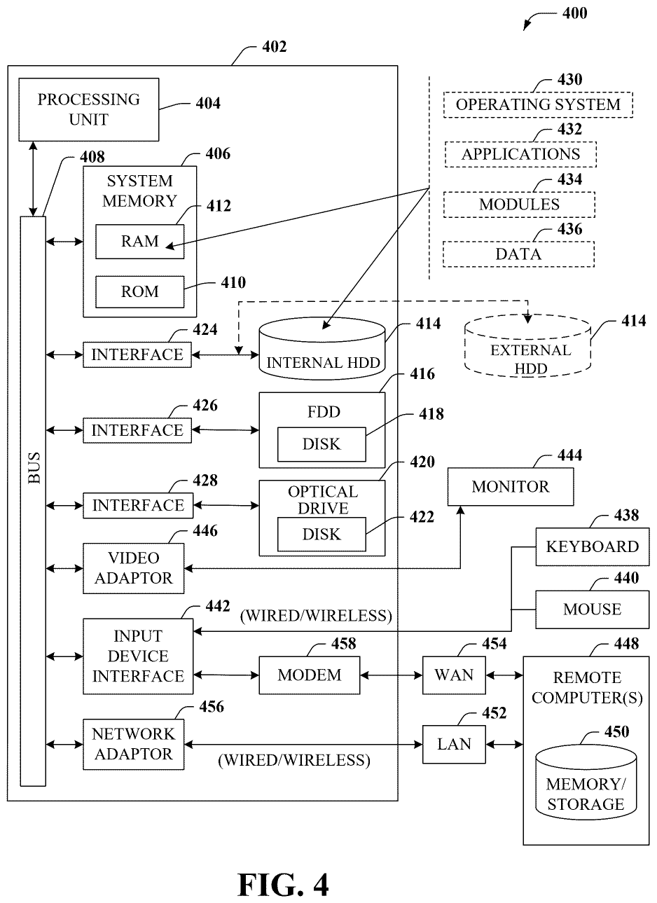

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part intelligent network type selection.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

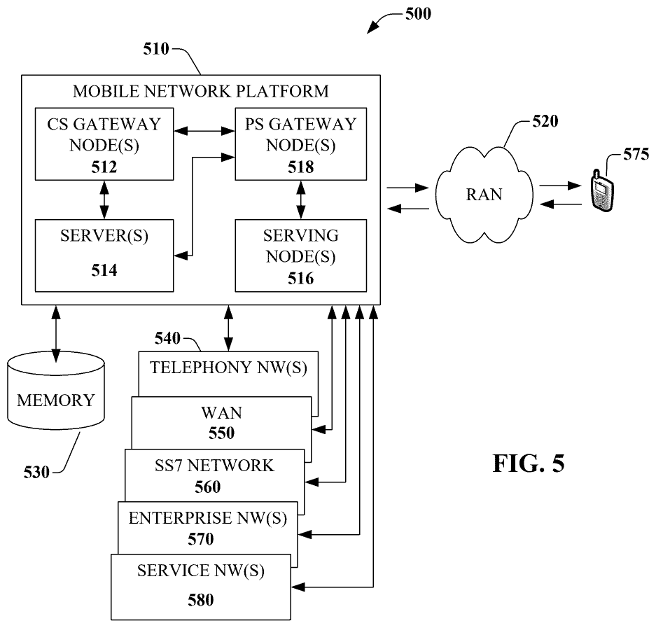

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part intelligent network type selection. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

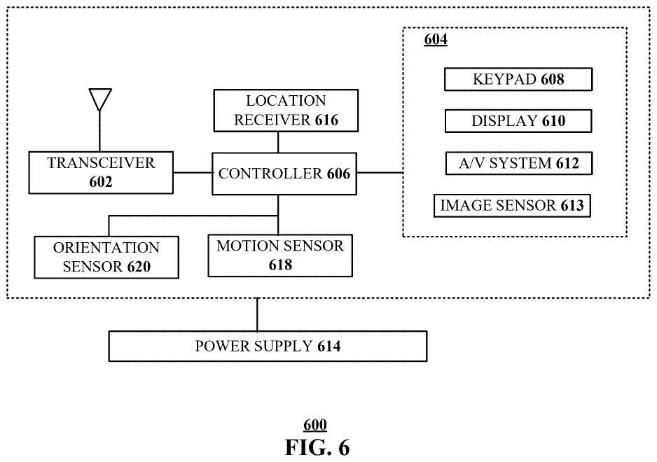

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part intelligent network type selection.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A network device, comprising:
a processing system including a processor; and
a memory that stores executable instructions that, when executed by the processing system, facilitate performance of operations, the operations comprising:
collecting network performance data describing current network load conditions;
receiving data from a user equipment (UE) about current processing capabilities of the UE;
analyzing the network performance data and the data from the UE to determine a suitable network type;
reconfiguring a network connection to route traffic of the UE through the suitable network type.

2. The network device of claim 1, wherein the operations further comprise:
continuously monitoring the current network load conditions; and
updating the suitable network type.

3. The network device of claim 1, wherein the operations further comprise:
providing a recommendation to the UE on the suitable network type; and
receiving, from the UE, a network type preference, wherein the reconfiguring the network connection comprises reconfiguring the network connection to route the traffic of the UE through a network connection having a type of the network type preference.

4. The network device of claim 1, wherein the network performance data further comprises available bandwidth.

5. The network device of claim 1, wherein the network performance data further comprises latency.

6. The network device of claim 1, wherein the network performance data further comprises performance of different network types.

7. The network device of claim 1, wherein the data from the UE further comprises battery status.

8. The network device of claim 1, wherein the data from the UE further comprises application requirements.

9. A non-transitory machine-readable medium, comprising executable instructions that, when executed by a processing system including a processor, facilitate performance of operations, the operations comprising:
collecting, by a user equipment (UE), data about current processing capabilities of the UE and application requirements of an application running on the UE;
providing, to an equipment of a network, the data about the current processing capabilities of the UE and the application requirements of the application running on the UE;
receiving, from the equipment of the network, a recommendation regarding a suitable network type, the suitable network type being either a classical Radio Access Network (RAN) or a virtualized Radio Access Network (vRAN);
analyzing, by the UE, the recommendation regarding the suitable network type to make a decision on a preferred network type between the classical RAN and the vRAN;
communicating, to the equipment of the network, the preferred network type.

10. The non-transitory machine-readable medium of claim 9, wherein the operations further comprise adjusting, by the UE, its settings to optimize performance based on the preferred network type.

11. The non-transitory machine-readable medium of claim 9, wherein the data about the current processing capabilities of the UE further includes battery status.

12. The non-transitory machine-readable medium of claim 9, wherein the recommendation from the equipment of the network includes an analysis of current network load conditions and available bandwidth.

13. The non-transitory machine-readable medium of claim 9, wherein the decision on the preferred network type is based on a comparison of processing power requirements of the application requirements of the application running on the UE and the current processing capabilities of the UE.

14. The non-transitory machine-readable medium of claim 9, wherein the data about the application requirements of the UE includes Quality of Experience (QoE) requirements for the running applications.

15. The non-transitory machine-readable medium of claim 9, wherein the UE stores historical data on network performance and application requirements to improve future network type selection decisions.

16. A method, comprising:
collecting at a user equipment (UE), by a processing system including a processor, real-time data about application requirements of the UE;
receiving, by the processing system, a recommendation from an artificial intelligence/machine learning (AI/ML) engine on a network regarding a suitable network type based on network performance data and application requirements;
analyzing, by the processing system, the recommendation and the real-time data to make a decision on a network type preference;
communicating to the network, by the processing system, the network type preference; and
adjusting, by the processing system, UE settings to optimize performance based on the network type preference.

17. The method of claim 16, wherein the real-time data includes current processing capabilities.

18. The method of claim 16, wherein the real-time data includes battery status.

19. The method of claim 16, further comprising:
continuously monitoring, by the processing system, a performance of the UE; and
updating, by the processing system, the network type preference responsive to the performance of the UE.

20. The method of claim 16, further comprising:
dynamically re-evaluating, by the processing system, the network type preference in response to changes in network load or application requirements.
